(19) United States
(12) Patent Application Publication
(10) Pub. No.: US 2023/0104839 A1
(43) Pub. Date: Apr. 6, 2023

(54) PARTIAL PLANAR POINT CLOUD MATCHING USING MACHINE LEARNING WITH APPLICATIONS IN BIOMETRIC SYSTEMS

(71) Applicant: NEC Laboratories Europe GmbH, Heidelberg (DE)

(72) Inventors: Francesco Alesiani, Heidelberg (DE); Daniel Onoro-Rubio, Heidelberg (DE)

(21) Appl. No.: 17/666,598

(22) Filed: Feb. 8, 2022

Related U.S. Application Data
(60) Provisional application No. 63/251,081, filed on Oct. 1, 2021.

(51) Int. Cl. G06V 40/12; G06V 10/74; G06V 10/82; G06T 3/00; G06N 3/08

(52) U.S. Cl. CPC G06V 40/1365; G06V 10/761; G06V 10/82; G06T 3/0068; G06N 3/08

(57) ABSTRACT

A method for partial planar point cloud matching includes collecting partial point clouds and full point clouds. A graph is generated from the partial point clouds and a graph is generated from the full point clouds. A point cloud graph network is trained to predict a matching matrix using the graphs.

### CROSS-REFERENCE TO PRIOR APPLICATION

Priority is claimed to U.S. Patent Application No. 63/251,081, filed on Oct. 1, 2021, the entire disclosure of which is hereby incorporated by reference herein.

### FIELD

The present invention relates to machine learning, and in particular to a method, system and computer-readable medium for partial planar point cloud matching, which can be advantageously applied in technology areas such as biometrics.

### BACKGROUND

There are different approaches for fingerprint matching. Depending on the data that is used during the matching, the fingerprint matching problem approaches can be classified in two categories: minutiae based, and image supported. In the first category of minutiae based matching, an algorithm where the matching fully relies on the extracted minutiae information is used. The algorithms on this category typically involve intensive search algorithms and similarity metrics, and typically don't involve machine learning (see Ravi, et al., “Fingerprint Recognition Using Minutia Score Matching,” arXiv:1001.4186 (2010) and WO2020/254857, each of which is hereby incorporated by reference herein). In the second category of image supported matching, Nguyen, “End-to-End Latent Fingerprint Search,” arXiv:1812.10213 (2018), which is hereby incorporated by reference herein, makes a direct use of the extracted images, and the minutiae information is typically used as supporting knowledge. The recent works in this area typically involve machine learning models.

### SUMMARY

In an embodiment, the present invention provides a method for partial planar point cloud matching. Partial point clouds and full point clouds are collected. A graph is generated from the partial point clouds and a graph is generated from the full point clouds. A point cloud graph network is trained to predict a matching matrix using the graphs.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically illustrates a method and system for partial point cloud matching according to an embodiment of the present invention;

FIG. 2 schematically illustrates matching and the preservation of the distance and angles;

FIG. 3 schematically illustrates a system architecture and the implementation of training and test phases according to an embodiment of the present invention;

FIG. 4 schematically illustrates a method for determining contrastive loss according to an embodiment of the present invention;

FIG. 5 schematically illustrates a transformer neural network with spatial encoding according to an embodiment of the present invention;

FIG. 6 schematically illustrates improvement of the point cloud extraction provided for by embodiments of the present invention;

FIG. 7 schematically illustrates a method and system architecture for hand-palm print matching according to an embodiment of the present invention using a graph neural network; and

FIGS. 8-13 are graphical results of experiments demonstrating improvements provided by embodiments of the present invention.

### DETAILED DESCRIPTION

Embodiments of the present invention tackle the set matching problem, i.e., given a subset Q, the goal is to retrieve the original set 0 where the query subset is taken. In particular, the goal according to an embodiment of the present invention is to provide for the partial latent to full ten-print palm-print/fingerprint minutiae matching, where the latent samples stand for the impressions that are left on objects after touching them. The latent samples can be partial or complete (e.g., a part of a fingerprint or palm print, or a complete single fingerprint), and are typically noisy. The ten-print stands for the “clean” and accurate data that is typically retrieved by the scanners, and it is stored on a dataset. These clean samples could also be taken by inkpads. For example, the clean samples for the minutiae matching could be an entire palm-print including the full ten fingerprints taken by a scanner, and fingerprint matching of a partial fingerprint could be a sub-problem of matching of a partial palm-print. According to an embodiment, however, it is not always necessary that the clean data used as a reference is also noisy or partial (e.g., the reference database of clean data could contain unidentified palm prints). The minutiae are the locations in which the fingerprint lines are joining, splitting, or ending, and the associated features such as the angle of the union, the texture, or others. This embodiment has applications in forensic or biometric identification, security and authentication, among others.

Biometrics are used for a number of purposes such as authentication for access to a device, voting, security in public spaces (e.g., in airports) and in forensics, as well as in other scenarios where authentication or identity matching is provided for by technical systems. Embodiments of the present invention provide a method, system and computer-readable medium for partial point cloud matching that takes advantage from the underlying geometric properties of the point cloud, which is generated from the point features of images, such as from partial fingerprints or palm-prints. Embodiments of the present invention use machine learning to accelerate the matching process and show favorable performance on both virtual and real datasets.

Embodiments of the present invention provide a new mechanism for partial latent to ten-print matching of sets of minutiae using machine learning and data augmentation.

Although some existing approaches can find good matches, these approaches rely on heuristics. These heuristics are not trainable and require time to compute. In an embodiment, the present invention supports the use of black-box heuristics by:
1 Providing a ranking of the hypothesis (e.g. palm-prints) to process.
2. Providing a hint for the black-box solver to improve the speed of matching.
3. Providing a way to improve the feature extraction by iteratively evaluating the ML metrics.

According to an embodiment of the present invention, the point-cloud used to represent the hand or the fingerprints is considered to lay on a planar geometry and thus distances and angles are preserved in the partial print and the database prints. In particular, when the point cloud consists of planar points, the principle that distances and angles are preserved can be advantageously used.

In the following, a system architecture according to an embodiment of the present invention is described. The input to the system is the point cloud (minutia) that contains: the planar coordinate of the points extracted from the object (e.g., fingerprint/hand-palm print); the tangent angle; and (optionally) the local curvature at the points. The minutiae are locations where two lines are joining or ending, e.g., as an (x,y) location, and typically, include the angle a of the line. This data is determined by running a detector over an image of the object (e.g., a scan of a fingerprint). The system consists of:
1. A graph generator for generation of a graph from the input cloud points. The graph is generated by connecting the extracted minutiae using, e.g., a nearest-neighbor algorithm.
2. A point cloud encoder that preserves distances and angles (rotation), wherein each point has a feature (e.g., the two-dimensional location, line angle and/or image features). The point cloud encoder generates (feature) embeddings for the nodes in the graph. In particular, the encoder takes the points (of the point clouds), each composed of coordinates and angles (but could contain other information such as curvature or topology of the points and other features such as in the ORB or SIFT specifications), generates a graph among the points and, based on the graph (and using a transformer), generates an embedding (vector of values) for each node.
3. A match generator used to build a matching matrix from two feature matrices. The matching matrix contains an entry of each pair of nodes (size n1×n2, where n1 are the nodes of the first point clouds and n2 the nodes of the second point clouds). The feature matrix is the same as the embedding (for each node there is vector of features organized in a matrix). For example, for the first point cloud the matrix has size n1×k, where k is the number of features of the embedding.
4. A predictor module configured to predict the matching matrix and minimize the distance to the true match during the training phase. The predictor module generates as output the matching matrix (the predictions). The output is trained to be closest to the true match.
5. A predictor function configured to predict the matching matrix from the features of both the partial point cloud and the stored point clouds and to select the highest scoring matches.

The foregoing system components can comprise hardware processors configured to implement computer code stored in physical memory so as to execute the functions listed above or any method according to an embodiment of the present invention. The output of the system consists of:
1. The ranking of the candidates and associated cost.
2. The predicted matching matrix per candidate.

For each partial print (which can also be referred to as latent, or simply a “query” point-cloud), there are multiple candidates (the finger-prints or the palm-prints or in general other point clouds). For each candidate, there is generated 1) the matching matrix (which gives the correspondence of points in the input to the points in the candidate); and 2) the score of the overall match. For example, the score is the number of points re-identified or the (optimal) transport cost.

According to embodiments of the present invention, the following loss functions can be used:
1. The reconstruction loss function, where the goal is for the network to predict the matching matrix (examples of these losses are the 12, 11, cross-entropy, etc.).
2. The feature norm, there the goal is for the feature norm to be 1.
3. The contrastive loss on the batch: Given a batch of data, the goal is for the distance of the partial to the full point cloud to be minimized for the current sample and less than the other samples.

An exemplary algorithm for extracting coordinates, angles and/or curvature of points of minutiae, for each pixel of the image of the object, collects local image information (e.g., as in a convolution) and extracts local features, such as the direction of the gradient (which will give information on the tangent of the direction) and then filters the pixel on come criteria. Examples of local feature extraction algorithms which could be used include scale invariant feature transform (SIFT), speed up robust feature (SURF), binary robust independent elementary features (BRIEF) or oriented FAST and rotated BRIEF (ORB) (see, e.g., Karami, Ebrahim, et al., “Image Matching Using SIFT, SURF, BRIEF and ORB: Performance Comparison for Distorted Images,” Computer Vision and Pattern Recognition, arXiv: 1710.02726 (Oct. 7, 2017), which is hereby incorporated by reference herein), and/or a neural network could be used. The following is exemplary pseudocode for a local feature extraction algorithm which could also be used according to an embodiment:
for each pixel, select a patch (e.g. square patch):
   compute values on the local patch (e.g., color histograms, gradient of the colors, etc.);
      for fingerprints: compute the tangent of lines and where lines meet;
      encode these features in a vector;
for each pixel, check the pixel feature against neighbor pixels' features and decide if to keep the feature or not.

For the encoder network according to an embodiment of the present invention, the Graph Edge Convolution (see Wang, et al., “Dynamic graph cnn for learning on point clouds,” ACM Transactions On Graphics, 38, no. 5, pp. 1-12 (2019), which is hereby incorporated by reference herein) can be used, where the edge feature is proportional to the difference of the input feature of the nodes.

For graph generation from a point cloud according to an embodiment of the present invention, the k-nearest neighbors graph are considered from the input point cloud.

For computing the distance of the matching according to an embodiment of the present invention, the transport cost is used:

d(Z)=log<C,Z>

Cᵢⱼ=|cⱼ^{y}−ᵢ^{x}|²

where C is the cost matrix, whose entries are the cost of moving the i-point to the j-point; Z is a variable that specifies whether the i-point has been moved to the j-point; <C, Z>is the inner product of the two matrices (which can be also written as Σᵢ^{j}(Cᵢⱼ, Zᵢⱼ)); and d(Z) is the cost of moving all the variables with respect to the cost matrix C; thus, the cost is the Euclidean distance of the feature in the original space and the distance is computed as the inner product between the cost matrix and the matching matrix.

For variational features and matching according to an embodiment of the present invention, graph embeddings are represented by mean and variance. During training, sampling takes place from a Gaussian model whose mean and variance are trainable variables, and the reparametrization trick is used to sample during training. The reparametrization trick is used to differentiate through a random variable. Here, the sample is written as x=σu+μ, where a is the standard deviation and μ is the mean, while u is sampled on a fixed normal distribution N(0,1) of unit variance and zero mean. The corresponding sample will have normal distribution (μ, σ²), a normal distribution of mean μ and variance σ². Next, the derivatives of the two variables σ and μ are computed, which are now deterministic: f(u)=f(σ)+f(μ).

Advantages of using the variational model include:
1. Improved performance and reliance to noisy data points as the matching matrix is represented as random variables.
2. Availability of statistics (mean and variance) of the matching matrices, and the embeddings and output quantities allow subsequent steps to consider to prioritize the search.

In an embodiment, the present invention can be applied for data augmentation for extended training. In various contexts, the partial point cloud is not available. If information on the procedure of creation of the partial point cloud is available, the use of virtual partial cloud and virtual matching is considered. From the full point cloud, points are selected according to the creation procedure and it is generated from these points the virtual partial point cloud and the virtual matching (which point corresponds to which point). This virtual dataset is used in addition to other training data to improve training performance.

Embodiments of the present invention can be applied for box and random virtual point clouds. In the box case, a box of predefined size around a point is selected, and all the points inside the box are used a partial cloud points. In the random case, a predefined number of points are selected from the input cloud points and used as partial point cloud. These points may be perturbed with some random noise in the input features.

In an embodiment, the present invention provides a transformer network with 2D/3D spatial encoding. Here, the use of transformer network with a spatial encoding of the type (sin (w x), sin (w y), sin (w z), cos (w x), cos (w y), cos (w z)) is considered for different values of w to encode the spatial relative position.

In an embodiment, the present invention provides for optimal transport matching where differential optimal transport is used to perform the matching.

In an embodiment, the present invention provides for discrete selection of the points where a differentiable discrete gate is used to select which point to participate in the matching process.

In an embodiment, the present invention provides for optimization of the point cloud extraction where an embodiment of the method according to the present invention is used to improve the quality of the point cloud extraction.

Embodiments of the present invention, can be applied for technical applications such as fingerprint matching or hand-palm print matching, where the partial point cloud is used for matching fingerprints or hand-palm prints. Other embodiments of the present invention can be applied for planar image registration, where the method according to an embodiment of the present invention is used to register-align images, for example from satellite or drones.

Aspect 1: In an Aspect 1, the present invention provides a method for partial planar point cloud matching. Partial point clouds and full point clouds are collected. A graph is generated from the partial point clouds and a graph is generated from the full point clouds. A point cloud graph network is trained to predict a matching matrix using the graphs.

Aspect 2: The method according to Aspect 1, wherein the point cloud graph network is trained to predict the matching matrix by using a distance and angle preserving graph network to generate features that are rotation and translation invariant.

Aspect 3: The method according to Aspects 1 or 2, further comprising computing a matching score in each case as a transport cost between the matching matrix and a distance of an input feature from the partial point clouds with contrastive loss, wherein the input features include coordinates and angles.

Aspect 4: The method according to any of Aspects 1-3, further comprising providing statistics of the matching scores and the matching matrix using a variational approach.

Aspect 5: The method according to any of Aspects 1-4, wherein the transport cost is determined by comparing the predicted matching matrix to a true matching matrix.

Aspect 6: The method according to any of Aspects 1-5, wherein the matching scores are used to rank candidates, the candidates being a subset of the full point clouds and/or known point clouds stored in a database, the method further comprising selecting a highest scoring one of the candidates as a match.

Aspect 7: The method according to any of Aspects 1-6, further comprising predicting the matching matrix using the trained point cloud graph network, and using the predicted matching matrix to run a further point cloud matching method.

Aspect 8: The method according to any of Aspects 1-7, further comprising applying the trained point cloud graph network for matching partial finger prints and/or hand-palm prints to a complete set.

Aspect 9: The method according to any of Aspects 1-8, further comprising applying the trained point cloud graph network for planar image registration.

Aspect 10: In an Aspect 10, the present invention provides a system for partial planar point cloud matching, the system comprising one or more hardware processors, which alone or in combination are configured to execute the following steps: collecting partial and full point clouds; generating a graph from the partial point clouds and a graph from the full point clouds; and training a point cloud graph network to predict a matching matrix using the graphs.

Aspect 11: The system according to Aspect 10, wherein the point cloud graph network is trained to predict the matching matrix by using a distance and angle preserving graph network to generate features that are rotation and translation invariant.

Aspect 12: The system according to Aspect 10 or 11, wherein the system is further configured to compute a matching score in each case as a transport cost between the matching matrix and a distance of an input feature from the partial point clouds with contrastive loss, wherein the input features include coordinates and angles.

Aspect 13: The system according to any of Aspects 10-12, wherein the system is further configured to provide statistics of the matching scores and the matching matrix using a variational approach.

Aspect 14: The system according to any of Aspects 10-13, wherein the transport cost is determined by comparing the predicted matching matrix to a true matching matrix, and/or wherein the matching scores are used to rank candidates, the candidates being a subset of the full point clouds and/or known point clouds stored in a database, the system being further configured to select a highest scoring one of the candidates as a match.

Aspect 15: In an aspect 15, the present invention provides a tangible, non-transitory computer-readable medium having instructions thereon, which upon being executed by one or more processors, provide for execution of a method according to an embodiment of the present invention.

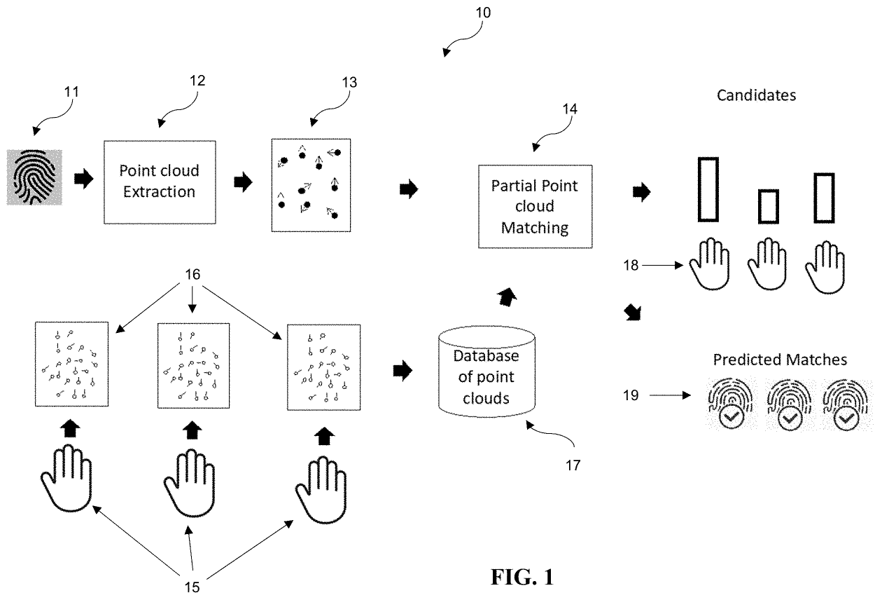

FIG. 1 schematically shows a method and system 10 for partial point cloud matching. This exemplary embodiment is applied for fingerprint or palm-print matching. The system 10 receives one or more partial latent prints 11 and complete prints 15. The partial latent prints 11 can be, e.g., a fingerprint or palm-print and the complete prints 15 can be, e.g., full ten-prints or full palm prints which are, e.g., taken from a scanner. Point cloud extraction 12 is applied to the partial latent prints 11, in particular the minutia as the input data, to generate an input point cloud graph 13. Likewise, complete point cloud graphs 16 are extracted from the complete prints 15, and are stored in a database of point clouds 17. The database of point clouds can also include partial point clouds, and these partial point clouds can be used in the matching. Partial point cloud matching by a point cloud graph network 14 is performed between the input point cloud graph 13 and the complete point cloud graphs 16 to determine a set of candidates 18 and predicted matches 19. The point cloud graph network 14 includes, in an embodiment, an edge graph neural network (edgeGNN). The images of the hands are the set of candidates 18 (e.g., identifiers of full candidate palm prints), while the symbols with the fingerprints are the predicted matches 19, which are in this example a set of correspondences between a point in the latent sample and a point in the candidate palm prints (e.g., a point map). There are two predictions. For each candidate palm print in the set of candidates 18, the predictions are: 1) the score of the palm (how likely it is to be the true palm, e.g., based on score, ranking and/or distance); and 2) the match of the point between the latent prints 11 and the full palm predicted matches 19.

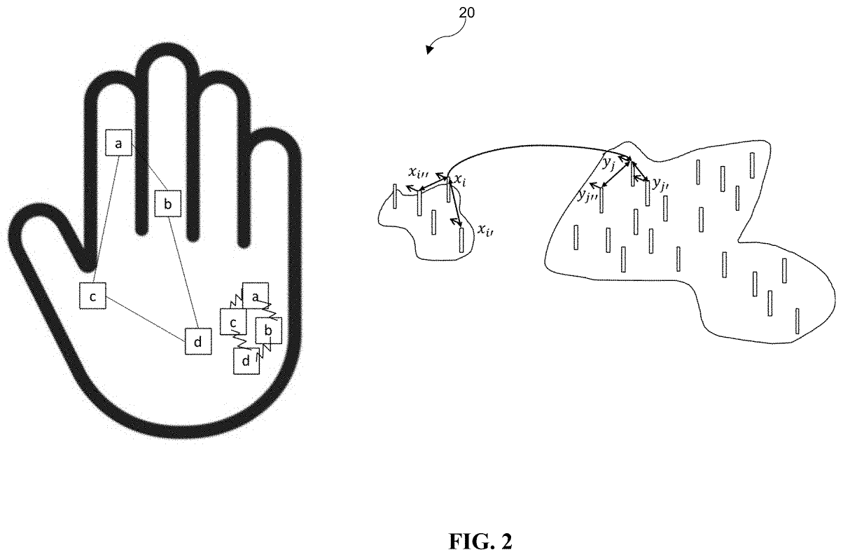

FIG. 2 illustrates a matching method 20 to preserve the distance and angles. The left side of FIG. 2 shows a hand and palm. In the palm, there are two hypothesis for the matching of the latent sample points a, b, c, d. One match (on the left) maintains the distances among the points a, b, c, d. The other match (lower part, right), could be a similar match (when looking at the points separately), but this match does not preserve distances. The right side of FIG. 2 shows the latent (x) on the left and the palm (y) on the right. The match on the right maintains the distances and the angles. In this example, some points are not present in the two point clouds and there is also a rotation on the points.

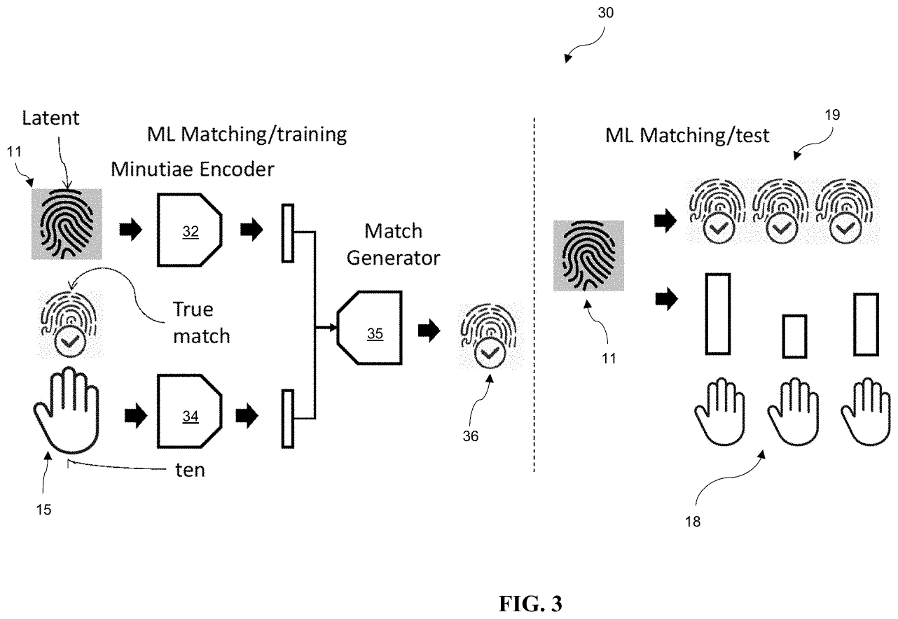

FIG. 3 schematically illustrates a method and system 30 for fingerprint and/or palm-print matching with a training phase (left side) and test phase (right side). In the training phase, the inputs include the partial latent prints 11 and the complete prints 15, wherein there are samples of the partial latent prints and the corresponding palm, plus the correct correspondences, to train and learn a model. From the point clouds of the partial latent prints 11 and the complete prints 15, their corresponding encodings (output of minutiae encoders 32, 34) are used to generate a match 36 using a match generator 35. The minutiae encoders 32,24 and the match generator 35 together form a point cloud graph network. In the test phase, there is input to the model a new partial latent print 11, typically not seen before. The process described with reference to FIG. 1 is repeated to get the matches for each of the set of candidates 18, or potentially matching ones of the complete prints 15, that are in the local database to be scored against. A set of predicted matches 19 is output for each candidate palm in the set of candidates 18, wherein the bars above the hand symbols in FIG. 3 represent different matching scores. The highest scoring one of the predicted matches 19 is chosen as the match.

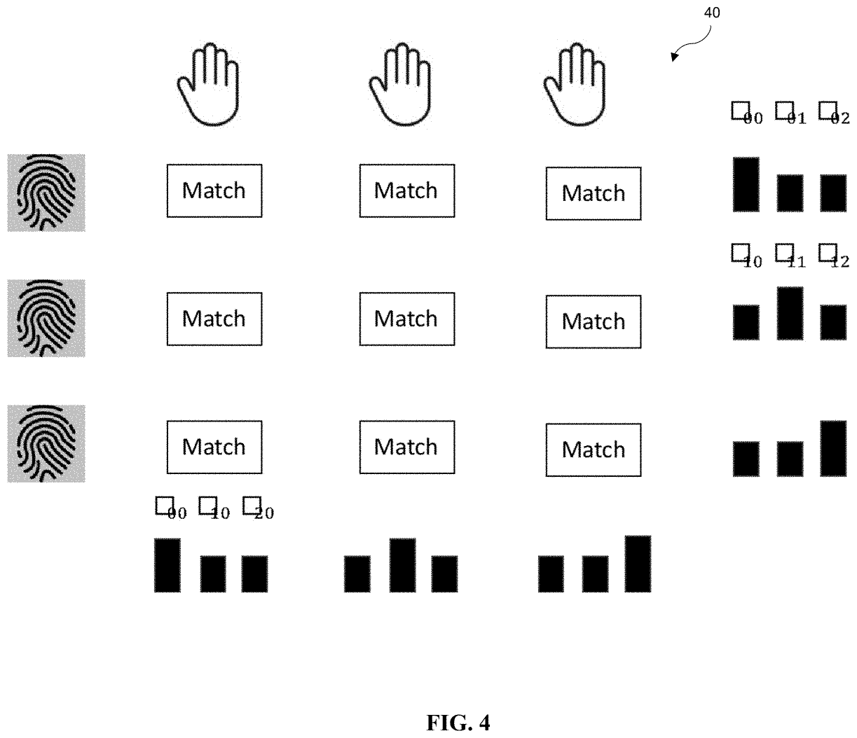

FIG. 4 shows the contrastive loss at the batch level during the training phase. The row contrastive loss is more important and is asking that the match of the partial latent prints 11 with the respective matching complete print 15 is higher than with other ones of the complete prints 15. In this example, a batch of three samples are received, wherein each sample is composed of a latent partial print 11 and its corresponding complete print 15. A matrix of scores is generated, where each latent partial print 11 is evaluated against each corresponding complete print 15 (3×3=9 entries). The application of contrastive loss provides that the score for the correctly matching pair (latent-palm) is higher than the other pairs (latent-palm', where palm' is not a correct match). The bars in FIG. 4 indicate a matching score for each matrix location. Here, the match refers to the sample pair (latent-palm) and not the point cloud match. The contrastive loss can be performed in accordance with the following pseudocode:
for all training data, split the data in batches;
for each batch in the training, compute the score (optimal transport cost) for all possible pairs (cross samples);
   generate a loss that penalizes incorrect pair matches;
   update the minutiae encoders 32, 34 and match generator 35 (see FIG. 3) based on the gradient against the generated loss (in addition to the cloud match reconstruction loss);
repeat over multiple epochs.

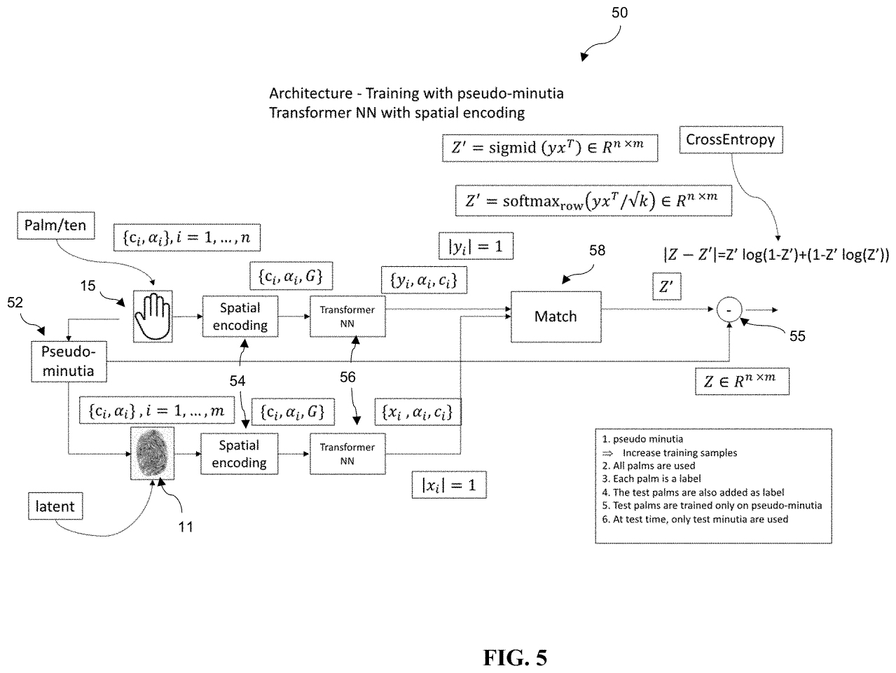

FIG. 5 shows a method and system 10 using a transformer neural network with spatial encoding as one practical application according to an embodiment of the present invention. For training, there are complete prints 15 (e.g. full-ten and/or complete palm prints), and partial latent prints 11 (which can be actual samples or can be created from parts of the complete prints 15 using the pseudo-minutia component 52 that takes parts of the complete prints 15) that are correctly matched. Accordingly, the training data is composed of a sequence of (complete (palm), latent, true match). The complete prints 15 and partial latent prints 11 are spatially encoded with the spatial encoders 54 (e.g., derived by the coordinates such as the sin and cos of the coordinates at different frequencies, sin(σx), cos(σx), sin(σy), cos(σy) for different σ. Then, the transformer neural networks 56 are used for encoding and the outputs are provided to the match generator 58 (the transformer networks 56 and the match generator 58 being part of a trained point cloud graph network for predicting the matching matrix), the output of which is used to build the training loss by applying a contrastive loss 55 of the output with the pseudo-minutia. In the formulas of FIG. 5:
G: The positional encoding build from the point cloud. This is typically sin/cos at various frequencies.
xᵢ: The coordinates of the points from the palm (point-cloud1).
yⱼ: are the coordinates of the points from the finger-print (point-cloud2).
k: dimension of the features.
x^{T}: T indicates the transpose of x.
R: is the set of real numbers.
n: number of points in the first point-cloud (palm).
m: number of point in the second point-cloud(fingerprint).
Z′: the predicted matching matrix.
Z: the true matching matrix.

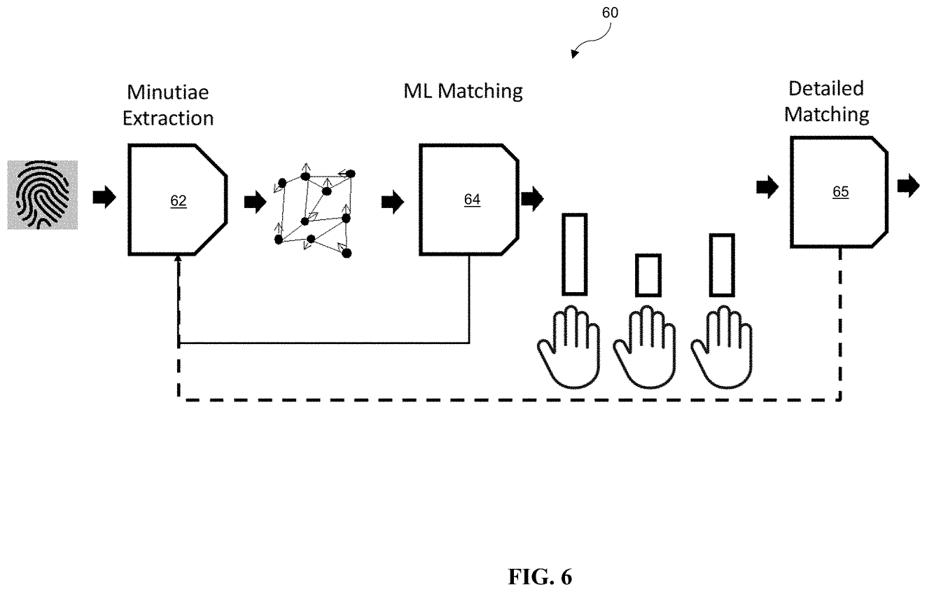

FIG. 6 shows improvements to the point cloud extraction and matching 60 according to an embodiment of the present invention, in particular where the minutiae extraction component 62 as the feature extraction part is trained or modified. The minutiae extraction component 62 converts from sensor input (e.g., images or LIDAR) to point clouds and is expected to have some parameters. The output of the minutiae extraction component 62 is a graph which is input to the ML matching component 64 which is trained to output the set of candidates 18 according to an embodiment of the present invention. According to an embodiment, it is also possible to apply a black box detailed matching component 65. The function of the detailed matching component 65 is the same as the ML matching component 64 except that a different algorithm (e.g., based on the golden standard) is used and the performance is typically slower. The output of the ML matching component 64 and/or the detailed matching component 65 is used to update the configuration (parameters) of the minutiae extraction component 62. If the minutiae extraction component 62 is differentiable, then the minutiae extraction component 62 and the ML matching component 64 can be updated together in a differentiable manner. The point cloud extraction and matching 60 can be implemented in accordance with the following exemplary pseudocode:
set initial parameter of the minutiae extraction component 62;
extract minutiae from partial latent prints 11 using the minutiae extraction component 62;
compute performance of the ML matching component 64 and/or the detailed matching component 65;
update parameters of the minutiae extraction component 62 in a way that final performance is improved.

For the ML matching component 64, the performance can be computed by determining composite loss on the matching matrix and on the error with respect to the true match, for example, the ranking of the candidates (a ranking of one is correct and the lower the ranking, the larger the error). For the detailed matching component 65, the performance can be simply determined by the error in the matching after the black box.

There are two type of updates possible: 1) change the algorithm that extracts the minutia (if there are multiple algorithms); and/or 2) change the parameters of the extraction algorithm, for example the number of extracted points, a window where the points are compared with other points or thresholds on activate points or different methods to compute the angles. To determine the degree of improvement from an update, it is possible to: 1) compute the change (e.g., iteratively) along a single dimension, for example, by changing a single parameter to whether this change improves performance; 2) use some random or grid configuration of the extraction and select the best over all possible combination; 3) use either a random Markov tree search or Bayesian optimization to navigate the possible configuration. This area is called hyper-parameter optimization and includes a number of existing approaches. If the extraction module is differentiable, then learning can be end-to-end.

According to one embodiment, multiple parallel minutiae extraction components 62 are ensembled (combined), where the parameters are in this case the probabilities of getting a point cloud from one of the these parallel components.

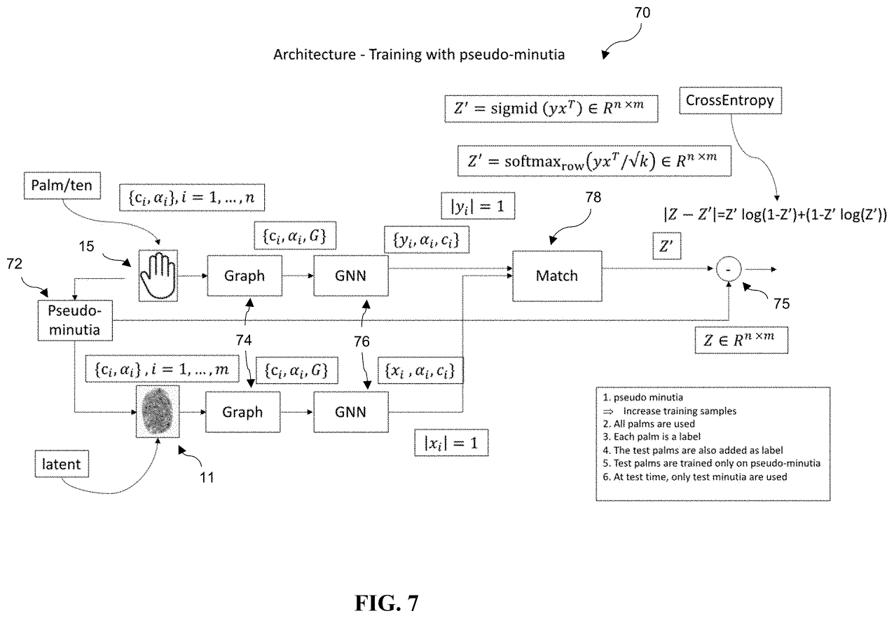

FIG. 7 shows a method and system 70 using graph neural networks (GNNs) 76 as another practical application according to an embodiment of the present invention. As opposed to the embodiment of FIG. 5, this embodiment uses a graph generation modules 74 followed by spatial GNNs 76. In other words, the position encoder is now the graph generation and the transformer is now a distance-aware GNN (e.g., edgeGNN). The spatial GNNs 76 and the match generator 78 are part of a trained point cloud graph network for predicting the matching matrix. The spatial GNNs 76 use the graph, but it has some parameters that are learned. One example of a GNN is a graph convolutional network (GCN) defined as composition of σ(ÃH^{p}W^{p}) where σ, Ã, H^{p}, W^{p} are the non linear activation function, the normalized adjacent matrix, the feature matrix and the network parameters, respectively. Preferably, the spatial GNNs 76 are the edgeGNNs that work with only the distances of the points and not the node coordinates (input features). For training, there are complete prints 15 (e.g. full-ten and/or complete palm prints), and partial latent prints 11 (which can be actual samples or can be created from parts of the complete prints 15 using the pseudo-minutia component 72 that takes parts of the complete prints 15) that are correctly matched. Accordingly, the training data is composed of a sequence of (complete (palm), latent, true match). The complete prints 15 and partial latent prints 11 are input to the graph generation modules 74. Then, the spatial GNNs 76 are used and the outputs are provided to the match generator 78, the output of which is used to build the training loss by applying a contrastive loss 75 of the output with the pseudo-minutia. In the formulas of FIG. 7:
G: the graph build from the point-cloud.
xᵢ: the coordinates of the points from the palm (point-cloud1).
yⱼ: the coordinates of the points from the finger-print (point-cloud2).
k: dimension of the features.
x^{T}: T indicates the transpose of x.
R: is the set of real numbers.
n: number of points in the first point-cloud (palm).
m: number of points in the second point-cloud(fingerprint).
Z′: the predicted matching matrix.
Z: the true matching matrix.

The graph is a set of points and the edges that connects points (and can also be referred to as a graph network). The graph in some cases contains mainly the edges of nodes that are connected. The graph, for example, can be computed by the graph generation modules using the k-nearest neighbor algorithm. Spatial encoding has a similar role for the transformer and helps the transformer understand which nodes are close and which are far. It is typically defined by sine and cosine function at multiple frequencies: sin(2 πf₁xᵢ), cos(2 πf₁xᵢwhere f₁ are the frequencies and xᵢ represents the coordinate of the point.

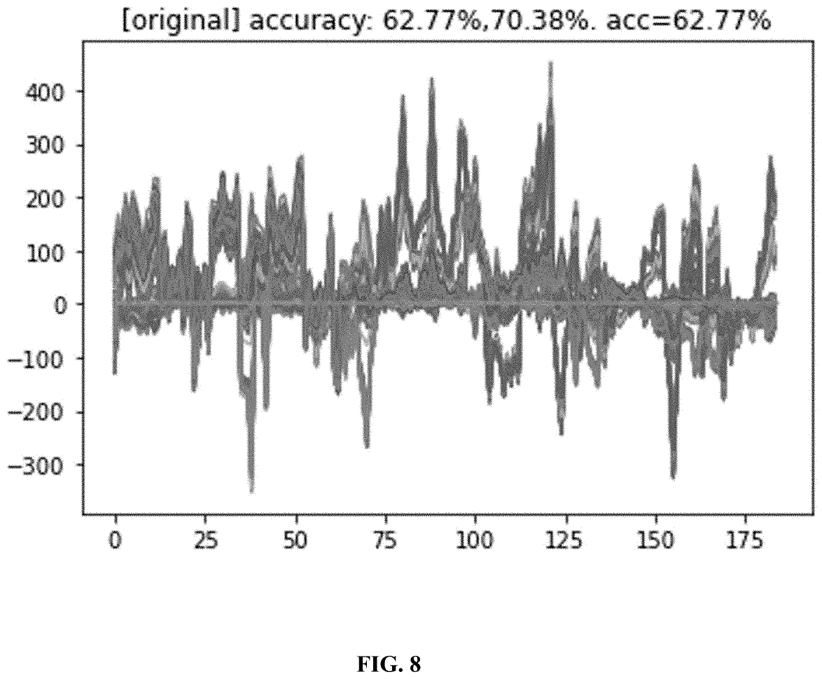

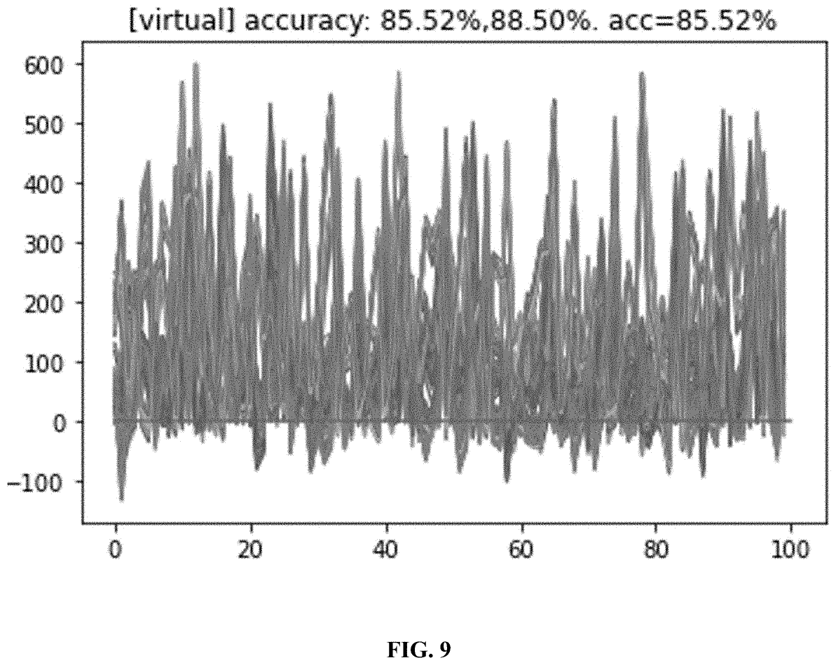

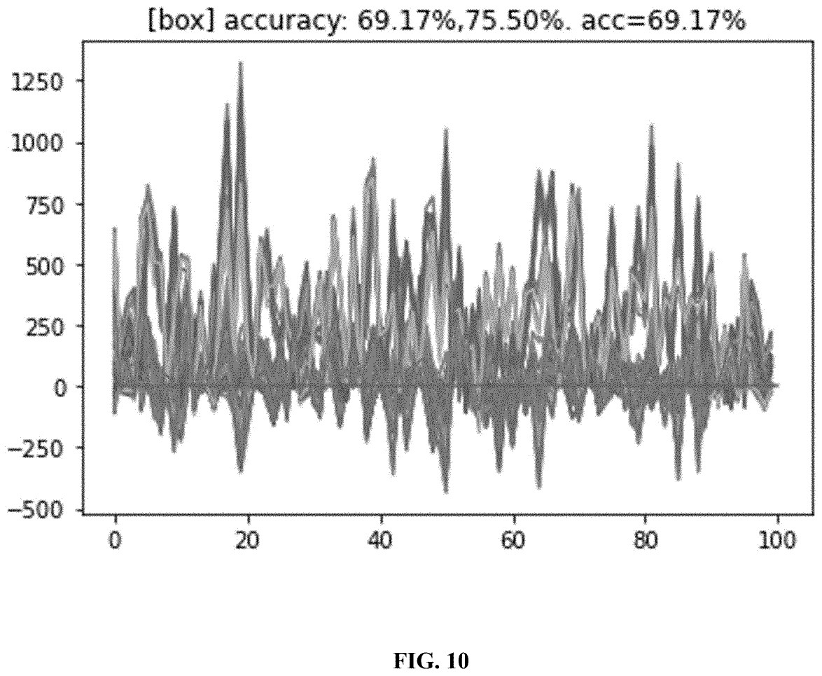

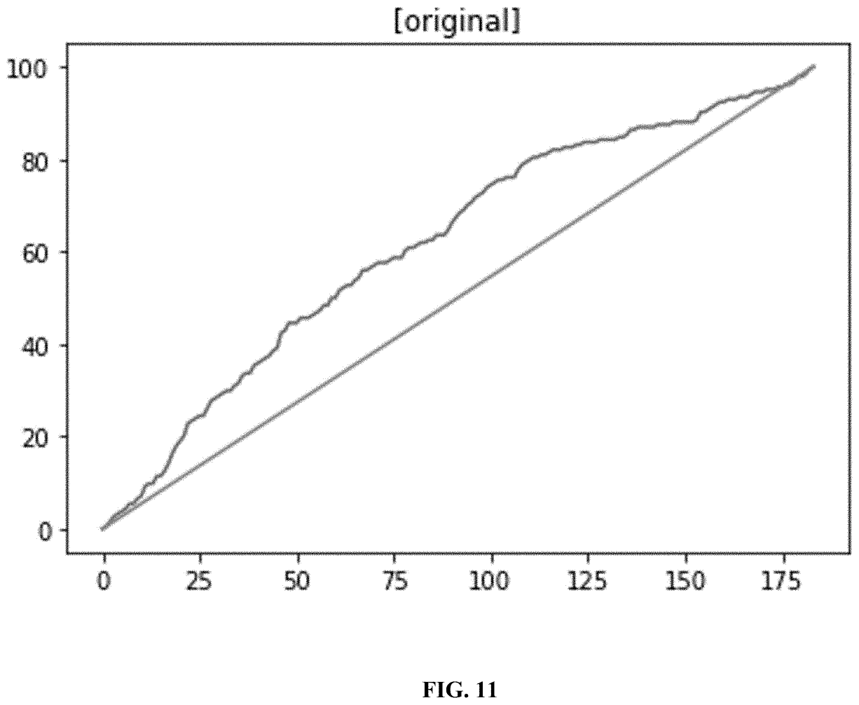

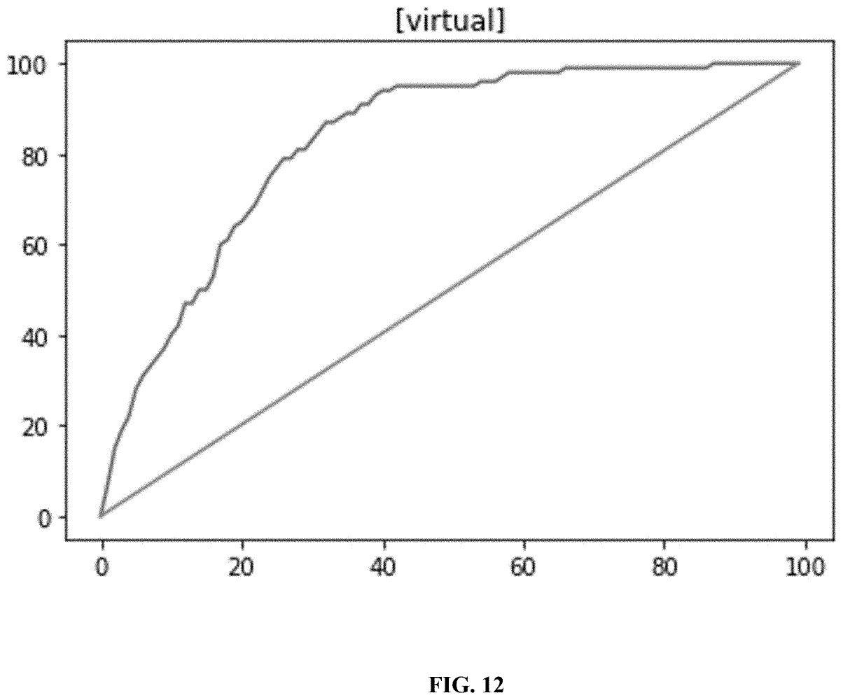

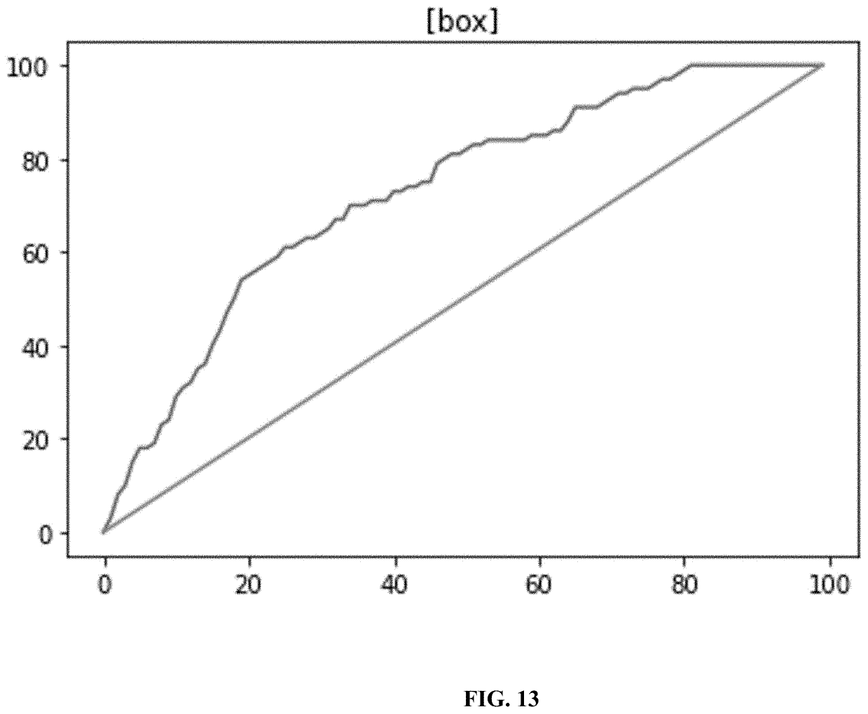

FIGS. 8-13 graphically demonstrate results of experiments showing improvements achieved by embodiments of the present invention. FIGS. 11-13 visualizes the same information as FIGS. 8-10, in particular three types of training (with real data (FIGS. 8 and 11), and with pseudo-samples (random (FIGS. 9 and 12) and bounding box FIGS. 10 and 13) according to embodiments of the present invention) in a different manner. FIGS. 8-10 show the first hundred samples and their relative rank or score. The sample is scored at zero. If the curve is below zero, this means that another sample has been scored higher. If the line is above zero, this means that other samples are scored lower. The goal is to have all the lines (sample scoring against the other samples) be above zero. The more lines above zero, the better the algorithm performs. FIGS. 11-13 show the rankings as a more clear representation of the performance, in which a random ranking system is the diagonal line [0-175]->[0-100] and the algorithm according to embodiments of the present invention is the other curve which is above the diagonal line. The higher this curve is above the diagonal line, the better the algorithm performs as the area between the two lines measures the performance. As demonstrated by FIGS. 8-13, embodiments of the present invention are able to achieve enhanced accuracy, along with the other improvements discussed herein, such as enhanced computational speed and power and/or conserving computational resources.

Embodiments of the present invention provide for the following improvements over existing computer systems and approaches:
1. Enabling to predict the point cloud matching matrix using a generative graph network.
2. Using a distance and angle preserving graph network to generate features that are rotation and translation invariant.
3. Computing the score of the matching as a transport cost between the matching matrix and the distance of the input feature (e.g., coordinates and angles) with contrastive loss and providing the statistics of the matching score and matching matrix using the variational approach.
4. Reducing the number of the potential candidate to 60%.
5. Providing a starting matching for further processing.

In an embodiment, the present invention provides a method comprising the steps of:
1. Collect the partial and full point clouds.
2. Generate the graph from the point clouds. The graph can be generated in accordance with the following pseudocode:
normalize the points features (if applicable);
compute the distance between each pair of points d_{i,j}, the distance can be the Euclidean distance |xᵢ−xⱼ|² or a composition of distances;

from the distance matrix, extract the graph (e.g., using the k-nearest neighbors).
3. Train a point cloud graph network to predict the matching matrix, e.g., using a distance and angle preserving graph network to generate features that are rotation and translation invariant, and computing the score of the matching as a transport cost between the matching matrix and the distance of the input feature (e.g., coordinates and angles) with contrastive loss, and providing the statistics of the matching score and matching matrix using the variational approach. The variational approach models the variables as random variables and uses the reparametrization trick to train the model. In this way, a distribution of models or variables is learned instead of a deterministic model. The model will output a distribution of solutions defined by the parameters of the models. By modelling the variables of the model as a distribution, it is possible to obtain a more stable and rich description, e.g., for associating a probability to the prediction.
4. In a use phase, using the learned matching prediction against the cost of transport from the input feature, and/or using the match prediction to select the highest score points clouds. This generates the matching scores for each of the candidates. For each input, a matching score is generated using the transport cost for all candidates, and the highest score candidate is selected. The transport cost uses two matrices: 1) the cost matrix C to compute from the coordinates (and angles) of the points of the two point-clouds (input point cloud and candidate); and 2) the matching matrix Z, predicted according to embodiments of the present invention. The predicted matching matrix is compared with the true matching matrix that is used in training. For the contrastive loss, the score among all candidates and all input point cloud in the training batch is also used. The matching scores are additionally used to rank the candidates.
5. Optionally, using the predicted matches (matching matrix) to run a more advanced and complex point cloud matching method.

Embodiments of the present invention can be applied to improve biometric detection systems, such as those used for security in airports and Smartcity computer systems.

Embodiments of the present invention use a graph neural network to generate the matching matrix.

Embodiments of the present invention significantly reduce the time needed for matching.

Parameters of the system according to an embodiment of the present invention include, for the training phase, k-nn and dimension of the features and, for the test phase, sensibility for the ranking. For example, there could be parameters such as 1) number of neighbors for building a graph, and/or 2) size of the embedding for the encoder and decoder. At test time, there could be parameters to tune the sensitivity of the distance calculation (transport cost) or the generative model hyper-parameters (e.g., temperature of the softmax).

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for partial planar point cloud matching, the method comprising:
collecting partial and full point clouds;
generating a graph from the partial point clouds and a graph from the full point clouds; and
training a point cloud graph network to predict a matching matrix using the graphs.

2. The method according to claim 1, wherein the point cloud graph network is trained to predict the matching matrix by using a distance and angle preserving graph network to generate features that are rotation and translation invariant.

3. The method according to claim 1, further comprising computing a matching score in each case as a transport cost between the matching matrix and a distance of an input feature from the partial point clouds with contrastive loss, wherein the input features include coordinates and angles.

4. The method according to claim 3, further comprising providing statistics of the matching scores and the matching matrix using a variational approach.

5. The method according to claim 3, wherein the transport cost is determined by comparing the predicted matching matrix to a true matching matrix.

6. The method according to claim 3, wherein the matching scores are used to rank candidates, the candidates being a subset of the full point clouds and/or known point clouds stored in a database, the method further comprising selecting a highest scoring one of the candidates as a match.

7. The method according to claim 1, further comprising predicting the matching matrix using the trained point cloud graph network, and using the predicted matching matrix to run a further point cloud matching method.

8. The method according to claim 1, further comprising applying the trained point cloud graph network for matching partial finger prints and/or hand-palm prints to a complete set.

9. The method according to claim 1, further comprising applying the trained point cloud graph network for planar image registration.

10. A system for partial planar point cloud matching, the system comprising one or more hardware processors, which alone or in combination are configured to execute the following steps:
collecting partial and full point clouds;
generating a graph from the partial point clouds and a graph from the full point clouds; and
training a point cloud graph network to predict a matching matrix using the graphs.

11. The system according to claim 10, wherein the point cloud graph network is trained to predict the matching matrix by using a distance and angle preserving graph network to generate features that are rotation and translation invariant.

12. The system according to claim 10, wherein the system is further configured to compute a matching score in each case as a transport cost between the matching matrix and a distance of an input feature from the partial point clouds with contrastive loss, wherein the input features include coordinates and angles.

13. The system according to claim 12, wherein the system is further configured to provide statistics of the matching scores and the matching matrix using a variational approach.

14. The system according to claim 12, wherein the transport cost is determined by comparing the predicted matching matrix to a true matching matrix, and/or wherein the matching scores are used to rank candidates, the candidates being a subset of the full point clouds and/or known point clouds stored in a database, the system being further configured to select a highest scoring one of the candidates as a match.

15. A tangible, non-transitory computer-readable medium having instructions thereon, which upon being executed by one or more processors, provide for execution of the following steps:
collecting partial and full point clouds;
generating a graph from the partial point clouds and a graph from the full point clouds; and
training a point cloud graph network to predict a matching matrix using the graphs.
